(19) United States
(12) Patent Application Publication
(10) Pub. No.: US 2023/0400711 A1
(43) Pub. Date: Dec. 14, 2023

(54) SMART EYEWEAR WITH ACCESS POINT FOR DATA INPUT/OUTPUT

(71) Applicant: GOOGLE LLC, Mountain View, CA (US)

(72) Inventors: Erturk Kocalar, Sunnyvale, CA (US); Srivatsan Ravindran, Cupertino, CA (US); Emily Cooper, San Francisco, CA (US); Steven Tran, San Jose, CA (US); Shiying Zhang, Santa Clara, CA (US)

(21) Appl. No.: 18/248,580

(22) PCT Filed: Oct. 13, 2020
(86) PCT No.: PCT/US2020/070659

§ 371 Date: Apr. 11, 2023

(51) Int. Cl. G02C 11/00; G02C 5/22

(52) U.S. Cl. CPC G02C 11/10; G02C 5/2281

(57) ABSTRACT

An eyewear includes a frame configured to hold a first lens and a second lens, a first temple connected to the frame using a first hinge, and a second temple connected to the frame using a second hinge. At least one of the first temple and the second temple includes one or more electronic components and at least one of the first hinge and the second hinge is electrically connected to at least one of the electronic components and is used as an electrical contact to access signals from the electronic components. Thus, at least one of the first hinge and the second hinge is electrically connected to at least one of the electronic components and provided to form an access point at the eyewear for accessing signals from the electronic components by connecting an external device to at least one of the first hinge and the second hinge.

### TECHNICAL FIELD

This description relates to smart eyewear with at least one access point for data input and/or data output.

### BACKGROUND

Eyewear (i.e., glasses, also known as eyeglasses or spectacles) are vision aids consisting of glass or hard plastic lenses mounted in a frame that holds them in front of a person's eyes. The eyewear typically utilize a nose bridge over the nose, and legs (known as temples or temple pieces), which rest over the ears.

Smart eyewear are glasses (or smart glasses) that add information alongside what the wearer sees through the glasses. Superimposing information (e.g., digital images) onto a field of view may be achieved through smart optics such as an optical head-mounted display (OHMD), or embedded wireless glasses with a transparent heads-up display (HUD), or augmented reality (AR) overlay. Modern smart eyewear are effectively wearable computers which can run self-contained mobile apps. Some may be handsfree and can communicate with the Internet via natural language voice commands, while others may use touch buttons.

Smart eyewear typically includes electronic components disposed in the eyewear. For example, electronic components may be additionally disposed in one or both of the temples. It is desirable to have access to the electronic components in order to perform certain functions such as, for instance, accessing debug messages, factory testing, accessing log files, and other functions, without adding contacts and/or connectors that add weight to the eyewear and that take away from the cosmetic look and/or feel of the eyewear.

### SUMMARY

According to one general aspect, an eyewear includes a frame configured to hold a first lens and a second lens, a first temple connected to the frame using a first hinge, and a second temple connected to the frame using a second hinge. At least one of the first temple and the second temple includes one or more electronic components and at least one of the first hinge and the second hinge is electrically connected to at least one of the electronic components and is used as an electrical contact to access signals from the electronic components. That is, at least one of the first hinge and the second hinge is thus electrically connected to at least one of the electronic components and provided to form an access point at the eyewear device for accessing signals from the one or more electronic components by connecting an external device to the least one of the first hinge and the second hinge.

Implementations may include one or more of the following features. For example, both the first hinge and the second hinge are electrically connected to at least one of the electronic components and are used as electrical contacts to access the signals from the electronic components.

In some implementations, the one or more electronic components include a debug port, the first hinge is used to access universal asynchronous receiver-transmitter transmit (UART TX) signals from the debug port, and the second hinge is used to access universal asynchronous receiver-transmitter receive (UART RX) signals from the debug port.

In some implementations, the first hinge includes a first pin that is electrically connected to at least one of the electronic components and is used as an electrical contact to access the signals from the electronic components, and the second hinge includes a second pin that is electrically connected to at least one of the electronic components and is used as an electrical contact to access the signals from the electronic components.

In some implementations, the frame further includes a nose bridge and the nose bridge is electrically connected to at least one of the electronic components and is used as an electrical contact to access signals from the electronic components.

In some implementations, the frame further includes nose pads and the nose pads are electrically connected to at least one of the electronic components and are used as electrical contacts to access signals from the electronic components.

In some implementations, the one or more electronic components include a switch and a debug microcontroller, an output of the switch electrically connects to the first hinge and the second hinge, and access to the signals from the one or more electronic components by the first hinge and the second hinge are controlled by the debug controller through the switch.

In some implementations, the signals from the electronic components are transitioned from a disabled state to an enabled state.

In another general aspect, An eyewear includes a frame configured to hold a first lens and a second lens, a first temple connected to the frame using a first hinge, a second temple connected to the frame using a second hinge, and one or more pins on an outside of the frame. At least one of the first temple and the second temple includes one or more electronic components and at least one of the one or more pins is electrically connected to at least one of the one or more electronic components and is used as an electrical contact to access signals from the electronic components.

Implementations may include one or more of the following features. For example, the one or more pins include one or more cosmetic fasteners. In some implementations, both the first hinge and the second hinge are electrically connected to at least one of the electronic components and are used as electrical contacts to access the signals from the electronic components.

In some implementations, the one or more electronic components include a debug port, the one or more pins include a first pin and a second pin, the first pin is used to access universal asynchronous receiver-transmitter transmit (UART TX) signals from the debug port, and the second pin is used to access universal asynchronous receiver-transmitter receive (UART RX) signals from the debug port.

In some implementations, the frame further includes a nose bridge and the nose bridge is electrically connected to at least one of the electronic components and is used as an electrical contact to access signals from the electronic components.

In some implementations, the frame further includes nose pads and the nose pads are electrically connected to at least one of the electronic components and are used as electrical contacts to access signals from the electronic components.

In some implementations, the signals from the electronic components are transitioned from a disabled state to an enabled state.

In another general aspect, an eyewear includes a frame configured to hold a first lens and a second lens, a first temple connected to the frame using a first hinge, a second temple connected to the frame using a second hinge, and a first pin on an outside of the frame, where at least one of the first temple and the second temple includes one or more electronic components and the first pin is removable and replaceable by a second pin that is electrically connected to at least one of the components and is used as an electrical contact to access signals from the electronic components.

In another general aspect, a method for accessing signals on eyewear includes triggering a debug mode on the eyewear, where the eyewear includes a frame configured to hold a first lens and a second lens, a first temple connected to the frame using a first hinge, a second temple connected to the frame using a second hinge, and one or more electronic components and accessing signals from the one or more electronic components through at least one of the first hinge and the second hinge.

Implementations may include one or more of the following features. For example, accessing the signals comprises accessing the signals from the one or more electronic components by both the first hinge and the second hinge.

In some implementations, accessing the signals further includes accessing universal asynchronous receiver-transmitter transmit (UART TX) signals through the first hinge and accessing universal asynchronous receiver-transmitter receive (UART RX) signals through the second hinge.

In some implementations, the frame includes a nose bridge and the method further includes accessing the signals from the one or more electronic components through the nose bridge.

In some implementations, the frame further includes nose pads and the method further includes accessing the signals from the one or more electronic components through the nose pads.

The details of one or more implementations are set forth in the accompanying drawings and the description below. Other features will be apparent from the description and drawings, and from the claims.

### BRIEF DESCRIPTION OF THE DRAWINGS

FIG. 1 is an example sketch of example smart eyewear.

FIG. 2 is an example sketch of example smart eyewear.

FIG. 3 is an example block diagram of the electronic components of the smart eyewear of FIGS. 1 and 2.

FIG. 4 is an example sketch of a metal component of smart eyewear in relation to electronic components of the smart eyewear.

FIG. 5 is an example sketch of a metal component of smart eyewear in relation to electronic components of the smart eyewear.

FIG. 6 is an example circuit diagram for accessing the electronic components of the smart eyewear through the metal components of the smart eyewear.

FIG. 7 is an example circuit diagram for accessing the electronic components of the smart eyewear through the metal components of the smart eyewear.

FIG. 8 is an example circuit diagram for accessing the electronic components of the smart eyewear through the metal components of the smart eyewear.

FIG. 9 is an example circuit diagram for accessing the electronic components of the smart eyewear through the metal components of the smart eyewear.

FIG. 10 is a flowchart illustrating example operations of using the metal components of smart eyewear to access electronic components in the smart eyewear.

FIG. 11 shows an example of a computer device and a mobile computer device that can be used to implement the techniques described here.

### DETAILED DESCRIPTION

This document describes smart eyewear (also referred to interchangeably as eyewear throughout) that uses one or more portions and/or parts of the frame and/or at least one temple as access points (also referred to as electrical contacts or test points) to access the electronic components disposed within the eyewear. This provides a technical solution to the technical problem described above of being able to access the electronic components disposed within the eyewear without using additional contacts and/or connectors that may add weight, complexity, and cost to the eyewear and that may take away from the cosmetic look and/or feel of the eyewear. This document also describes techniques for using the one or more portions and/or parts of the frame and/or at least one temple as electrical contacts that provide access to the electronic components disposed within the eyewear.

More specifically, the one or more portions and/or parts may include at least one metal component, which may be electrically connected to the electronic components. For example, the eyewear may include metal hinges and/or metal pins (or screws) that are electrically connected to the electronic components disposed within the eyewear such as within the frame and/or within one or both temples. The metal hinges and/or metal pins may be used as electrical contacts or access points to perform one or more various functions with the electronic components. In some implementations, the eyewear may include a metal portion and/or metal part of a nose bridge and/or of a nose pad electrically connected to the electronic components disposed within the eyewear. In particular, a metal nose bridge and/or metal nose pads may be provided. The metal nose bridge and/or metal nose pads may be used as electrical contacts or access points to perform one or more various functions with the electronic components. In some implementations, the eyewear may include one or more other metal components such as metal cosmetic decorative shapes, metal decorative pins, and/or metal screws that also may be electrically connected to the electronic components disposed within the eyewear. These other metal components also may be used as electrical contacts or access points to perform one or more various functions with the electronic components.

In some implementations, the eyewear may include a metal fastener (e.g., a screw or a pin) that is used for cosmetic and/or other functions (e.g., fastening eyewear components) in the eyewear. When the eyewear is a production unit (meaning a unit meant for use by a wearer) and with the wearer, the metal fastener may be too short (or not long enough) to make electrical contact with the electronic components disposed within the eyewear. When access is needed to the electronic components, for example, at the factory or a repair store, the shorter metal fastener may be removed and replaced with a longer metal fastener that is designed to make electrical contact with the electronic components and function as an access point. For example, an interface portion for electrically connecting the one or more electronic components is provided at the frame and/or at least one of the first and second hinges, where the first pin is arranged at the interface portion and configured to be removed and replaced by a second (access) pin, e.g., by a second pin differing in length from the first pin, if access to access signals from the one or more electronic components is to be provided via the interface portion.

In some implementations, the one or more of the metal components on the frame and/or at least one temple may be in an active state, meaning that the metal components may be used to access the electronic components. That is, one or more of the metal components may be electrically connected to the electronic components. In some implementations, the metal components on the eyewear frame may be in a disabled state until access to the electronic components is needed. That is, the metal components may be electrically isolated from the electronic components. When access to the electronic components is needed, the metal components may be placed in an active state. In some implementations, one metal component may be in an active state to assist in enabling other metal components to be placed in an active state. For example, a signal (e.g., a trigger signal) may be applied to the active metal component that causes the other metal components change from a disabled state to an active state.

Access to the electronic components disposed in the eyewear through the metal components in the frame provides access to signals from the electronic components. In some implementations, the access to signals includes access to development and/or debug signals and access to control signals, as well as access to other signals and functions. The access points also may function to enable uploading and/or downloading of software and/or firmware to the electronic components.

In some implementations, an external connector (e.g., probe(s), connector) may be connected to the metal components that function as the electrical contacts or access points to the electronic components disposed within the eyewear. In this manner, a computing device or other test equipment may be connected to the eyewear through the external connector and the metal components.

Examples herein refer to augmented reality (AR). As used herein, AR refers to a user experience in which a computing device facilitates a sensory perception that includes at least one virtual aspect and at least one aspect of reality. AR can be provided by any of multiple types of computing devices, including, but not limited to, a wearable device. As used herein, an AR headset refers to any computing device that facilitates AR. An AR headset can include, but is not limited to, smart eyewear or smart glasses or AR glasses, another wearable AR device, a tablet, a phone, or a laptop computer. In some types of AR, the user can perceive the aspect of reality directly with his or her senses without intermediation by the computing device. For example, some AR headsets are designed to beam an image (e.g., the virtual aspect to be perceived) to the user's retina while also allowing the eye to register other light that was not generated by the AR headset. In other types of AR, a computing device can improve, complement, alter, and/or enable the user's impression of reality (e.g., the real aspect to be perceived) in one or more ways. In some implementations, AR is perceived on a screen of a computing device's display device. For example, some AR headsets are designed with camera feedthrough to present a camera image of the user's surrounding environment on a display device positioned in front of the user's eye. The display device may be an in-lens micro display, a display projected on a lens surface, a display projected on a plane of a lens-less frame, or other type of display.

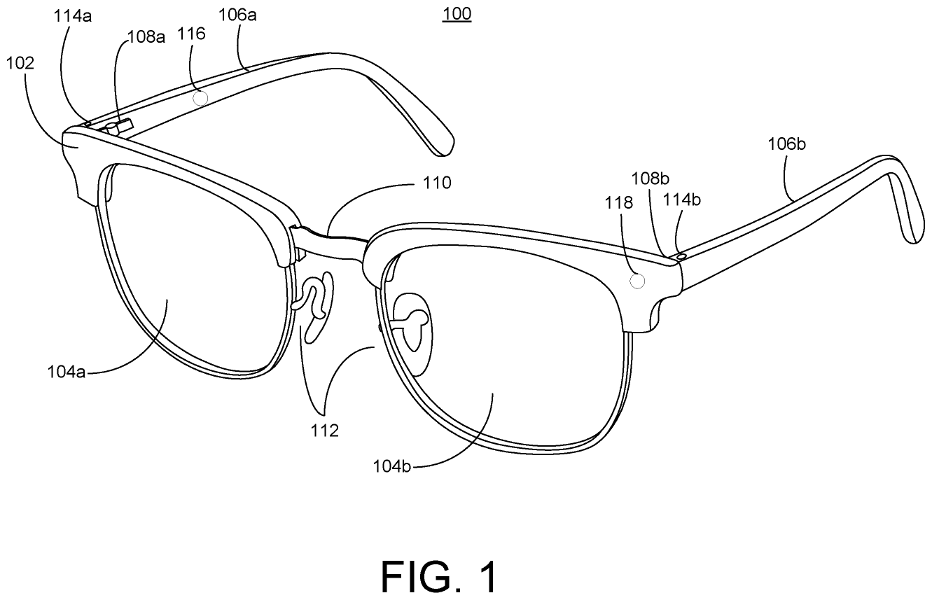

FIG. 1 illustrates an example sketch of example smart eyewear 100 (or simply eyewear 100). The eyewear 100 are glasses (or smart glasses) that add information alongside what the wearer sees through the glasses. For instance, the eyewear 100 can have virtual image displays (hereinafter “virtual display”) that add information to what a wearer sees through the glasses. A virtual display may, for example, be an in-lens micro display, or a display projected on a lens surface, or a display projected on a plane of a lens-less frame, etc. The eyewear 100 may be an AR headset.

In this example, the eyewear 100 includes a frame 102 that holds or secures a first lens 104a and a second lens 104b. The eyewear 100 includes a first temple 106a connected to the frame 102 using a first hinge 108a and a second temple 106b connected to the frame 102 using a second hinge 108b (with the second hinge not being visible in this view but the reference number pointing to its location). The frame 102 may include a nose bridge 110 and the nose bridge 110 may include nose pads 112. The first hinge 108a may include a first fastener 114a and the second hinge 108b may include a second fastener 114b, where the first fastener 114a and the second fastener 114b may be screws or pins or other types of fasteners.

Electronic components for controlling the eyewear 100 may be disposed within the eyewear 100. For example, the electronic components may be disposed in the first temple 106a and/or the second temple 106b and/or the frame 102. Flex circuits and/or wires may be used to connect the electronic components disposed within the eyewear 100 including to the first lens 104a and the second lens 104b. The eyewear 100 may include a button 116 such as a power or reset button to power on/off or reset the eyewear 100. The eyewear 100 also may include one or more sensors such as a camera 118. The camera 118 may provide information to the electronic components within the eyewear for use and processing of captured images and videos.

In this example, one or more of the first hinge 108a, the second hinge 108b, the nose bridge 110, the nose pads 112, the first fastener 114a, and the second fastener 114b may be electrically connected to at least one of the electronic components disposed within the eyewear 100 (e.g., the temples 106a and/or 106b) and used as an electrical contact or form an access point to access signals from the electronic components. The eyewear components including the first hinge 108a, the second hinge 108b, the nose bridge 110, the nose pads 112, the first fastener 114a, and the second fastener 114b may be made of metal, in part or in whole, to make the electrical connection with the electronic components within the eyewear. Any combination of one or more of these components may be electrically connected to the electronic components disposed in the eyewear.

For example, the first hinge 108a and the second hinge 108b may be metal hinges that are electrically connected to a debug port, which may be one of the electronic components in one of the temples 106a and 106b. The first hinge 108a may be used to access universal asynchronous receiver-transmitter transmit (UART-TX) signals from the debug port. The second hinge 108b may be used to access universal asynchronous receiver-transmitter receive (UART-RX) signals from the debug port. In this manner, a user may connect an external device to the first hinge 108a and the second hinge 108b such as a probe or connector to access these signals for processing by an external computing device or test equipment connected to the probe or connector. In some implementations, just one of the first hinge 108a and the second hinge 108b may be electrically connected to the debug port.

The accessible signals are not limited to UART-TX and UART-RX. For example, the accessible signals may include firmware recovery mode signals such as Device Firmware Update Mode (DFU) signals and Emergency Download (EDL) signals. The signals may include logging output signals such as UART output only. The signals may include Joint Test Action Group (JTAG) signals. The signals may include special control signals to enter a diagnostic and/or debug mode or signals to execute, including transmitting and receiving, special/diagnostic firmware. The signals may include special signals to indicate the software and/or firmware status, diagnostics, and error codes. The signals also may include other type of signals such as, for example, voltages, clocks, and general purpose input/output (I/O) (GIPO) signals. The signals may include a reset signal, which may be activated in cooperation with activation of the power button 116.

In this manner, the metal components of the eyewear 100 that are electrically connected to the electronic components provide access points to perform factory-related tests of the electronic components. The metal components of the eyewear 100 that are electrically connected to the electronic components also provide access points to perform debug and/or diagnostic tests at other points in time such as at a time of repair or return of the eyewear 100.

While the first hinge 108a and the second hinge 108b have been discussed above as electrical contacts or access points, the other metal components of the eyewear 100 also may be used in a same or similar manner. For example, in some implementations, the first hinge 108a and the second hinge 108b may not be metal, but the first fastener 114a and the second fastener 114b may be made of metal and may be electrically connected to the electronic components of the eyewear 100. The first fastener 114a and/or the second fastener 114b may be used as electrical contacts or access points. It is understood that in some implementations, the first hinge 108a, the second hinge 108b, the first fastener 114a, and the second fastener 114b may be made of metal and may be used as electrical contacts or access points.

In some implementations, the nose bridge 110 and/or the nose pads 112 may be made of metal and may be electrically connected to the electronic components of the eyewear 100. In this manner, the nose bridge 110 and/or the nose pads 112 may be used to access the electronic components and the signals discussed above.

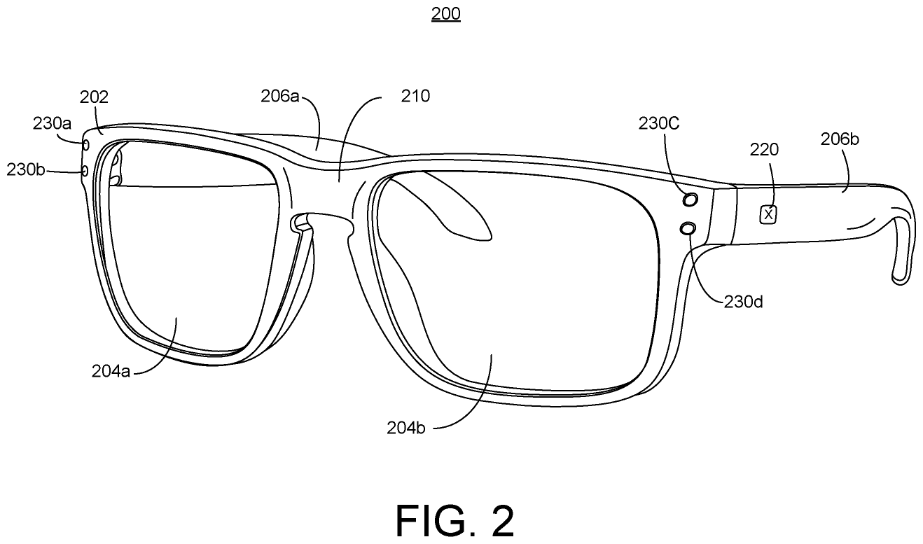

In some implementations, the other features of the eyewear may be used as electrical contacts. Referring to FIG. 2, another example smart eyewear 200 (or simply eyewear 200) is illustrated. The eyewear 200 may include some or all of the features and functionality of the eyewear 100 of FIG. 1, as described above. The eyewear 200 may be an AR headset.

The eyewear 200 includes a frame 202 that holds a first lens 204a and a second lens 204b. The frame 202 includes an integrated nose bridge 210. The eyewear 200 includes a first temple 206a and a second temple 206b. Electronic components may be disposed within the eyewear 200. For instance, electronic components may be disposed in the first temple 206a and/or the second temple 206b. The second temple 206b includes a decorative or cosmetic feature 220 that may be made of metal and also may function as an electrical contact or access point to the electronic components disposed in the second temple 206b.

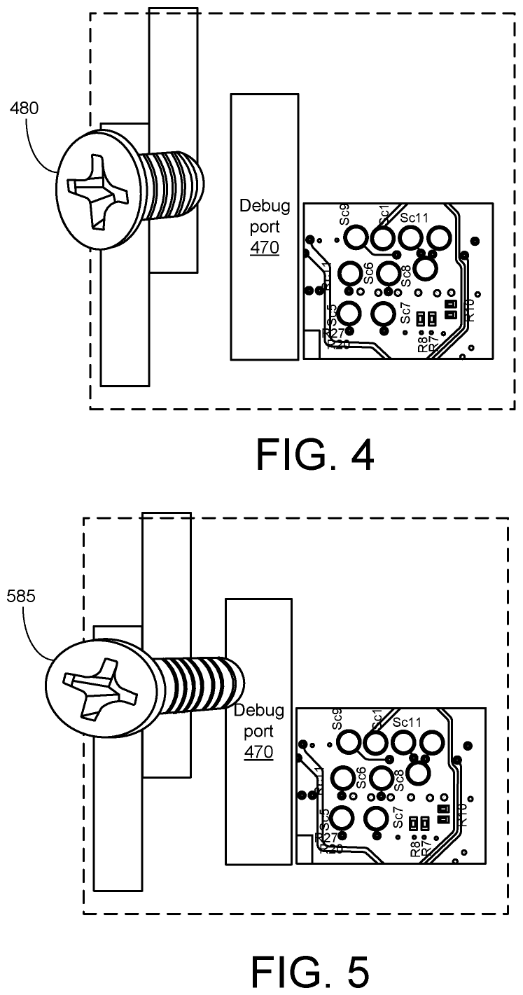

In some implementations, the cosmetic feature 220 may be a fastener, such as a screw, with a decorative head on the screw. The screw may function as the electrical contact or access point to the electronic components disposed in the second temple 206b. In some implementations, the cosmetic feature 220 may intentionally not be long enough to make electrical contact with the electronic components. But, if the eyewear 200 is returned or repaired where diagnostic or debug functions are to be used, the cosmetic feature 220 may be removed and replaced with a longer feature or screw that makes electrical contact with the electronic components in the second temple 206b. FIGS. 4 and 5 illustrate this concept of replacing the cosmetic feature 220 or screw with a longer screw when needed to make electrical contact with the electronic components, as discussed in more detail below.

In some implementations, the eyewear 200 may include pins 230a-d, which may function as cosmetic features and electrical contacts. For instance, one or more of the pins 230a-d may make electrical connections with one or more of the electronic components of the eyewear 200. Also, as discussed above, in some implementations, the pins 230a-d may not be long enough to make electrical contact with the electronic components. When debugging or diagnostic testing or access to the electronic components is needed, one or more of the pins 230a-d may be removed and replaced with one or more longer pins that are long enough to make electrical contact with the electronic components.

Referring to both FIGS. 1 and 2, in some implementations, one or more of the metal components of the eyewear 100 (first hinge 108a, the second hinge 108b, the nose bridge 110, the nose pads 112, the first fastener 114a, and the second fastener 114b) and one or more of the metal components of the eyewear 200 (cosmetic feature 220 and pins 230a-d) may be in an active state, meaning that the metal components may be used to access the electronic components. That is, one or more of the metal components may be electrically connected to the electronic components. In some implementations, the metal components on the eyewear 100 and eyewear 200 may be in a disabled state until access to the electronic components is needed. That is, the metal components may be electrically isolated from the electronic components. When access to the electronic components is needed, the metal components may be placed in an active (or enabled) state. In some implementations, one metal component may be in an active state to assist in enabling other metal components to be placed in an active state. For example, a signal (e.g., a trigger signal) may be applied to the active metal component that causes the other metal components change from a disabled state to an active state.

For example, the first hinge 108a may be in an active state and the second hinge 108b and/or the other metal components may not be in an active state (e.g., a disabled state). A trigger signal, such as a 5V signal, may be applied to the first hinge 108a to transition the second hinge 108b and/or other metal components to transition from the disabled state to the active state so that they can be used as electrical contacts.

In some implementations, all of the metal components that can be used as electrical contacts may be in an inactive or disabled state. The power button 116 may be used to cause a trigger signal to transition them from the inactive state to the active state. For instance, the power button 116 may be held for two power cycles to cause the trigger signal to the metal components. In some implementations, a connector to a port (not shown) on the eyewear 100 may be connected to a power source in conjunction with cycling the power button 116 for two cycles to cause the trigger signal to activate the metal components to function as electrical contacts.

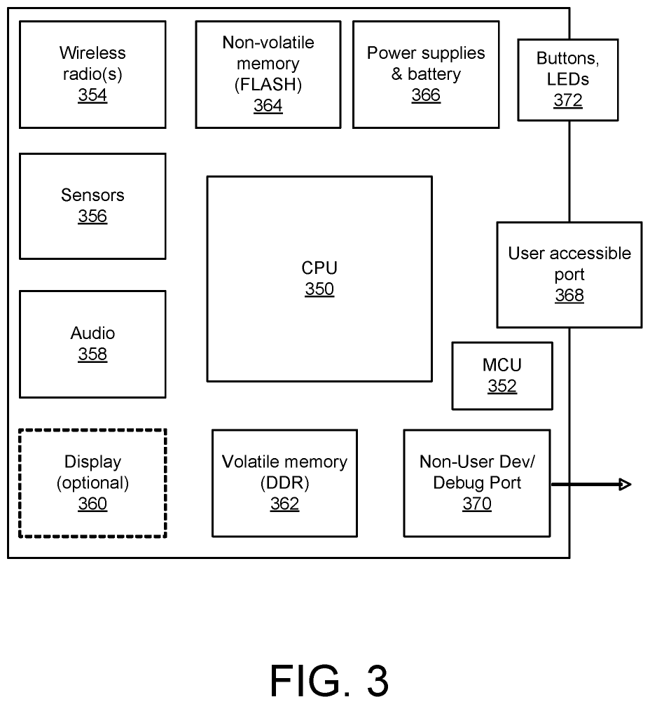

FIG. 3 illustrates an example block diagram of the electronic components that may be present in the eyewear 100 of FIG. 1 and the eyewear 200 of FIG. 2. The electronic components include a central processing unit (CPU) 350, a microcontroller (MCU) 352, a wireless radio(s) 354, sensors 356, an audio module 358, a display 360, volatile memory 362, non-volatile memory 364, power supplies and battery 366, a user accessible port 368, a non-user developer/debug port 370 (or simply debug port 370), and buttons and/or light emitting diodes (LEDs) 372.

The user accessible port 368 may include a visible port (e.g., Universal Serial Bus (USB)-type port) on the eyewear, which is not illustrated in FIG. 1 or 2 for simplicity. For instance, in some implementations, the user accessible port 368 may be located on the end of one of the temples such as on the end of the first temple 106a or the second temple 106b. The user accessible port 368 may be used for charging and/or optional communication of data.

As discussed above, the debug port 370 may be accessed through the one or more metal components of the eyewear 100 of FIG. 1 and the eyewear 200 of FIG. 2, as discussed above. The accessible signals through the debug port 370 through the eyewear metal components include, but are not limited to, the UART-TX and UART-RX signals, the firmware recovery mode signals such as DFU signals and EDL signals. The signals may include logging output signals such as UART output only. The signals may include JTAG signals, special control signals to enter a diagnostic and/or debug mode, or signals to execute, including transmitting and receiving, special/diagnostic firmware. The signals may include special signals to indicate the software and/or firmware status, diagnostics, and error codes. The signals may include a reset signal, which may be activated in cooperation with activation of the power button 116.

Referring to FIGS. 4 and 5, example sketches illustrates the use of a short fastener 480 (or cosmetic feature) being replaced with a longer fastener 585 (or cosmetic feature) to make electrical contact with the debug port 470. For instance, the fastener 480 may be similar to one of the pins 230a-230d discussed above with respect to FIG. 2. As discussed, in some implementations, the pins 230a-d may intentionally not be long enough to make electrical contact with the debug port (or a printed circuit board (PCB)), like the fastener 480. When debug or diagnostic tests are to be performed, one of the pins 230a-d may be removed and replaced with a longer pin, like the fastener 480 being removed and replaced with the longer fastener 585 that is designed to make electrical contact with the debug port 470. In this manner, the pins 230a-d remain inactive until access to the signals of the electronic components is desired and a longer fastener is used to replace the shorter fastener.

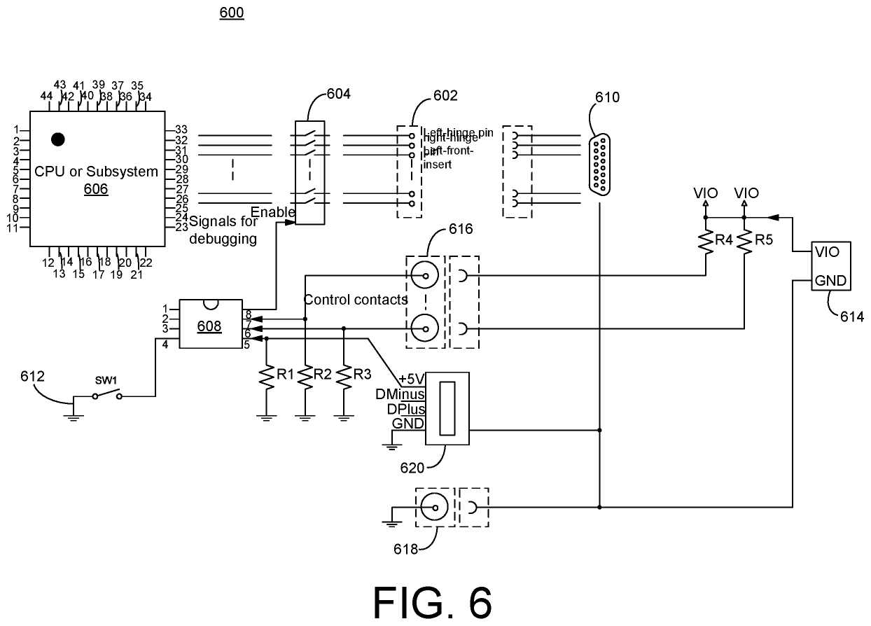

FIGS. 6-9 illustrate example circuit diagrams 600, 700, 800, and 900, respectively, for accessing the electronic components of the smart eyewear through the metal components of the smart eyewear. In the circuit 600 of FIG. 6, the metal components 602 (e.g., left-hinge pin, right-hinge pin, left-front cosmetic insert, etc.) of the eyewear are used to access the signals for debugging through a switch circuit 604, which may be similar to the debug port 370 of FIG. 3. The signals for debugging may be generated from the CPU 606 and the debug microcontroller 608 or any other circuit. A connector 610 combines the signals and may be plugged into an external host computing device or test equipment to process the signals.

In this example, the user accessible button 612 (i.e., power button) is used to enable or activate the signals, for example, by cycling the button 612 through two power cycles. The circuit 600 further includes a power supply 614 connected to control contacts 616 through resistors R4 and R5. There is an optional ground contact 618 if another ground is not available (i.e., from a USB connector). There is an optional USB connector 620, which may be used for power to enable the switch circuit 604. The USB connector 620 may provide power from a host device and/or power from the host may be in the logic that enables the switch circuit 604.

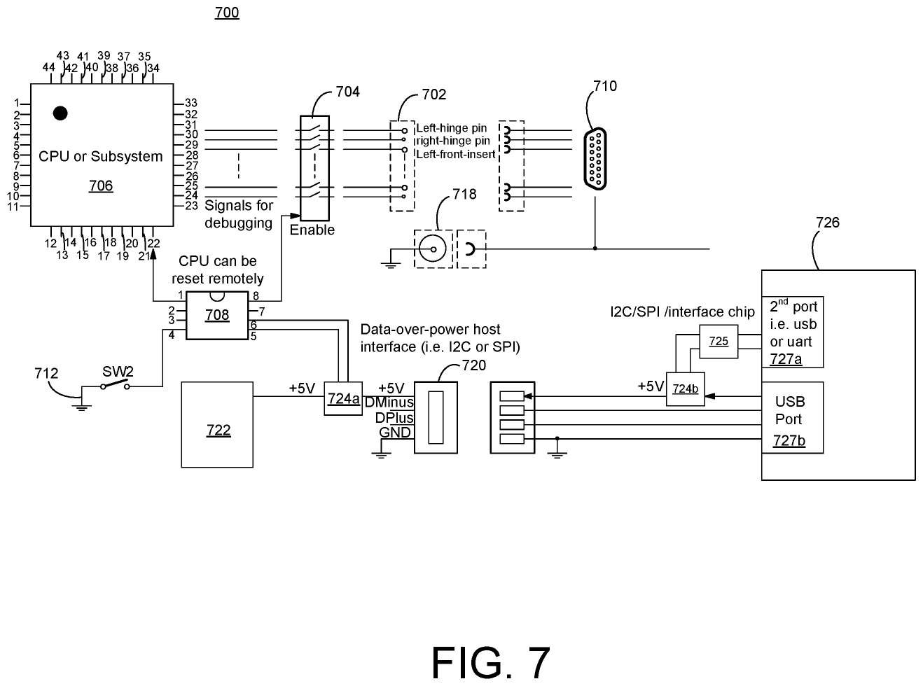

In circuit 700 of FIG. 7, a data-over-power schematic is illustrated. In the circuit 700, like the circuit 600, the metal components 702 (e.g., left-hinge pin, right-hinge pin, left-front cosmetic insert, etc.) of the eyewear are used to access the signals for debugging through a switch circuit 704, which may be similar to the debug port 370 of FIG. 3. The signals for debugging may be generated from the CPU 706 and the debug microcontroller 708 or other circuit. A connector 710 combines the signals and may be plugged into an external device, like an external host computing device or test equipment to process the signals. There is an optional ground contact 718 if another ground is not available (i.e., from a USB connector).

The circuit 700 includes a system power manager integrated chip (IC) 722 and a data-over-power subsystem IC 724a that connects to the debug microcontroller 708 and the user accessible USB connector 720. The USB connector 720 brings power to the eyewear. While a USB connector 720 is illustrated, it is understood that other connector such as two pins for power and ground may be used as well. A host device 726 may run debugging software and may use a dedicated (2n d) port 727a (i.e., a USB or uART port) or a USB port 727b. The host device 726 includes a matching data-over-power subsystem 724b to send commands either through the dedicated port 727a and an interface chip 725 or through the USB port 727b to the debug microcontroller 708 using the data-over-power subsystem IC 724a. The commands sent over can be as simple as enable switch component or enable/disable individual debug signals. The matching data-over-power subsystem ICs 724a and 724b enable power and data to be combined together on one side and then separated out on the other side. The communication may be unidirectional, meaning that one side combine and the other side separates, or the communication may be bi-directional, meaning that both sides can both combine power and data and separate power and data.

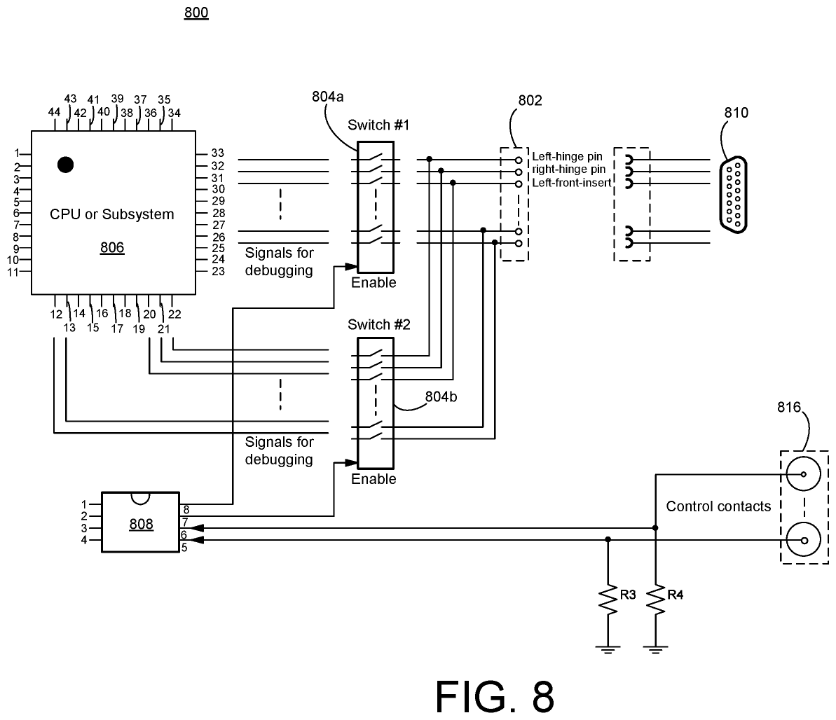

In circuit 800 of FIG. 8, multiplexing of the signals for debugging is illustrated using two switch circuits 804a and 804b. In the circuit 800, the metal components 802 (e.g., left-hinge pin, right-hinge pin, left-front cosmetic insert, etc.) of the eyewear are used to access the signals for debugging through two switch circuits 804a and 804b as controlled by the debug microcontroller 808. The signals for debugging may be generated from the CPU 706 and the debug microcontroller 708 or other circuit. A connector 810 combines the signals and may be plugged into an external device, like an external host computing device or test equipment to process the signals. The circuit 800 also includes control contacts 816.

The circuit 800 may be used when there are more debug signals than available number of contacts. The debug microcontroller 808 can be programmed to select a subset to be connected to the connector 810. The selection can be individual (i.e., per signal) or groups of signals. The former may include more complicated switch control signals, but will have more flexibility. The data over power may be used to determine which signals to connect or dedicated contacts may be used for select groups of signals (i.e., contact 1 selects switch 1 and contact 2 selects switch 2).

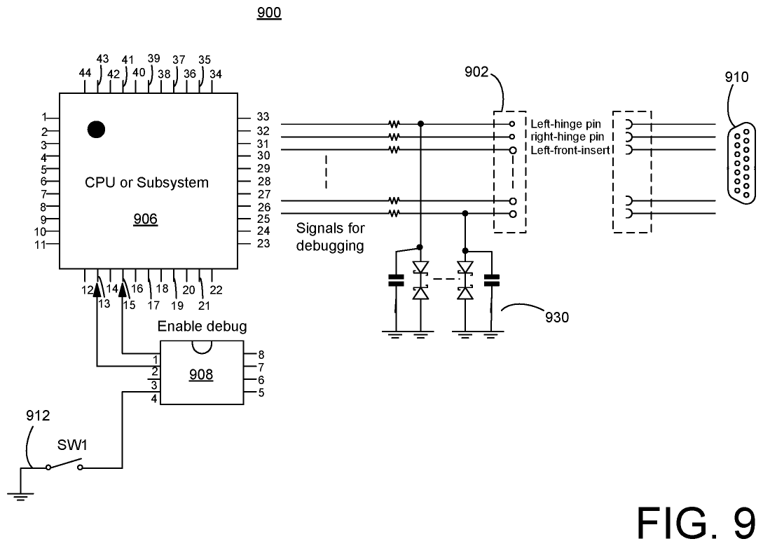

In circuit 900 of FIG. 9, the debug signals are always connected to the metal components 902 and there is no switch circuit, like the switch circuit 604 of circuit 600. In the circuit 900, the metal components 902 (e.g., left-hinge pin, right-hinge pin, left-front cosmetic insert, etc.) of the eyewear are used to access the signals for debugging from the CPU 906 or other circuits as controlled by the debug microcontroller 908. The signals for debugging may be generated from the CPU 906 or other circuits. A connector 910 combines the signals and may be plugged into an external device, like an external host computing device or test equipment to process the signals. The circuit 900 also include a user accessible button 912 (i.e., a power button).

In operation, when the debug microcontroller 908 detects a debug mode, the debug microcontroller 908 sends a signal to the CPU 906 to enable the debug signals. It is possible to send multiple control signals to select the debug mode or which signals to be enabled. The circuit 900 includes a set of Resistor, Capacitor, Diodes 930 to protect the debug signals from outside electrostatic discharge or to filter unwanted noise from leaking out.

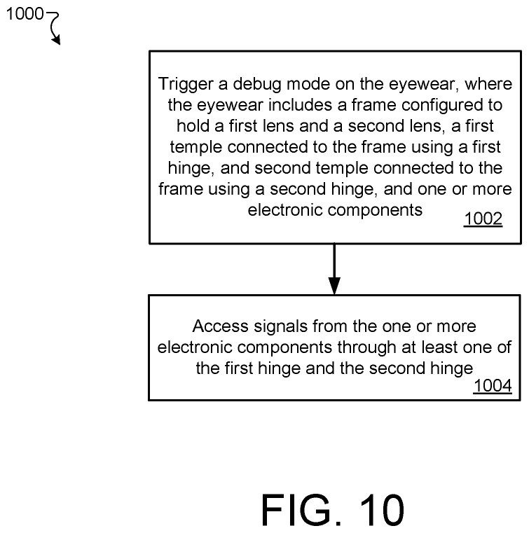

FIG. 10 is a flowchart illustrating example operations of using the metal components of smart eyewear to access electronic components in the smart eyewear. The example operations include an illustrative process 1000 for accessing signals on eyewear. Process 1000 includes triggering a debug mode on the eyewear, where the eyewear includes a frame configured to hold a first lens and a second lens, a first temple connected to the frame using a first hinge and a second temple connected to the frame using a second hinge, and one or more electronic components (1002). For example, the eyewear may be the example eyewear 100 of FIG. 1 or the example eyewear 200 of FIG. 2. In some implementations, a signal may be applied to one of the metal components such as the first hinge to enable the debug mode on the eyewear, meaning that signals from the electronic components are enabled. In some implementations, the debug mode on the eyewear may be triggered by any of the example techniques discussed above with respect to the circuit diagrams of FIGS. 6-9.

Process 1000 includes accessing signals from the one or more electronic components through at least one of the first hinge and the second hinge (1004). For example, signals from the one or more electronic components may be accessed by at least one of the first hinge 108a of FIG. 1 and the second hinge 108b of FIG. 1. In this manner, at least one of the first hinge 108a and the second hinge 108b is thus electrically connected to at least one of the electronic components and provided to form an access point at the eyewear 100 for accessing signals from the one or more electronic components by connecting an external device to the at least one of the first hinge 108a and the second hinge 108b.

In some implementations, accessing the signals (1004) includes accessing the signals from the one or more electronic components through both the first hinge and the second hinge. In some implementations, accessing the signals (1004) further includes accessing UART-TX signals through the first hinge and accessing UART-RX signals through the second hinge. In some implementations, the frame further includes a nose bridge and accessing the signals (1004) includes accessing the signals from the one or more electronic components through the nose bridge. In some implementations, the frame further includes nose pads and accessing the signals (1004) includes accessing the signals from the one or more electronic components through the nose pads.

It is understood that such systems and techniques may be applied to devices other than eyewear. For example, the concepts described herein may be applied to smart watches and/or smart phones. That is existing structural components of the smart watches and/or smart phones may be used as access points to access signals from the electronic components disposed within the device.

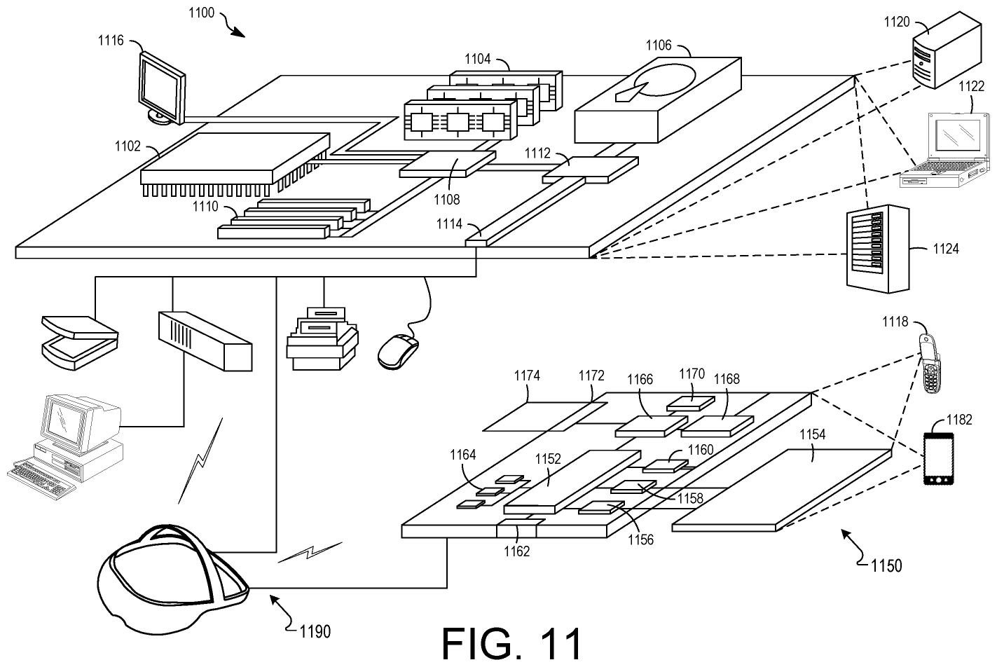

FIG. 11 shows an example of a computer device and a mobile computer device that can be used to implement the techniques described here. FIG. 11 shows an example of a generic computer device 1100 and a generic mobile computer device 1150, which may be used with the techniques described here. Computing device 1100 is intended to represent various forms of digital computers, such as laptops, desktops, tablets, workstations, personal digital assistants, televisions, servers, blade servers, mainframes, and other appropriate computing devices. Computing device 1150 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1100 includes a processor 1102, memory 1104, a storage device 1106, a high-speed interface 1108 connecting to memory 1104 and high-speed expansion ports 1110, and a low speed interface 1112 connecting to low speed bus 1114 and storage device 1106. The processor 1102 can be a semiconductor-based processor. The memory 1104 can be a semiconductor-based memory. Each of the components 1102, 1104, 1106, 1108, 1110, and 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as display 1116 coupled to high speed interface 1108. In other implementations, multiple processors and/or multiple buses may be used, as appropriate, along with multiple memories and types of memory. Also, multiple computing devices 1100 may be connected, with each device providing portions of the necessary operations (e.g., as a server bank, a group of blade servers, or a multi-processor system).

The memory 1104 stores information within the computing device 1100. In one implementation, the memory 1104 is a volatile memory unit or units. In another implementation, the memory 1104 is a non-volatile memory unit or units. The memory 1104 may also be another form of computer-readable medium, such as a magnetic or optical disk.

The storage device 1106 is capable of providing mass storage for the computing device 1100. In one implementation, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1104, the storage device 1106, or memory on processor 1102.

The high speed controller 1108 manages bandwidth-intensive operations for the computing device 1100, while the low speed controller 1112 manages lower bandwidth-intensive operations. Such allocation of functions is exemplary only. In one implementation, the high-speed controller 1108 is coupled to memory 1104, display 1116 (e.g., through a graphics processor or accelerator), and to high-speed expansion ports 1110, which may accept various expansion cards (not shown). In the implementation, low-speed controller 1112 is coupled to storage device 1106 and low-speed expansion port 1114. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. It may also be implemented as part of a rack server system 1124. In addition, it may be implemented in a personal computer such as a laptop computer 1122. Alternatively, components from computing device 1100 may be combined with other components in a mobile device (not shown), such as device 1150. Each of such devices may contain one or more of computing device 1100, 1150, and an entire system may be made up of multiple computing devices 1100, 1150 communicating with each other.

Computing device 1150 includes a processor 1152, memory 1164, an input/output device such as a display 1154, a communication interface 1166, and a transceiver 1168, among other components. The device 1150 may also be provided with a storage device, such as a microdrive or other device, to provide additional storage. Each of the components 1150, 1152, 1164, 1154, 1166, and 1168, are interconnected using various buses, and several of the components may be mounted on a common motherboard or in other manners as appropriate.

The processor 1152 can execute instructions within the computing device 1150, including instructions stored in the memory 1164. The processor may be implemented as a chipset of chips that include separate and multiple analog and digital processors. The processor may provide, for example, for coordination of the other components of the device 1150, such as control of user interfaces, applications run by device 1150, and wireless communication by device 1150.

Processor 1152 may communicate with a user through control interface 1158 and display interface 1156 coupled to a display 1154. The display 1154 may be, for example, a TFT LCD (Thin-Film-Transistor Liquid Crystal Display) or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may be provide in communication with processor 1152, so as to enable near area communication of device 1150 with other devices. External interface 1162 may provide, for example, for wired communication in some implementations, or for wireless communication in other implementations, and multiple interfaces may also be used.

The memory 1164 stores information within the computing device 1150. The memory 1164 can be implemented as one or more of a computer-readable medium or media, a volatile memory unit or units, or a non-volatile memory unit or units. Expansion memory 1174 may also be provided and connected to device 1150 through expansion interface 1172, which may include, for example, a SIMM (Single In Line Memory Module) card interface. Such expansion memory 1174 may provide extra storage space for device 1150, or may also store applications or other information for device 1150. Specifically, expansion memory 1174 may include instructions to carry out or supplement the processes described above, and may include secure information also. Thus, for example, expansion memory 1174 may be provide as a security module for device 1150, and may be programmed with instructions that permit secure use of device 1150. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1164, expansion memory 1174, or memory on processor 1152, that may be received, for example, over transceiver 1168 or external interface 1162.

Device 1150 may communicate wirelessly through communication interface 1166, which may include digital signal processing circuitry where necessary. Communication interface 1166 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1168. In addition, short-range communication may occur, such as using a Bluetooth, WiFi, or other such transceiver (not shown). In addition, GPS (Global Positioning System) receiver module 1170 may provide additional navigation- and location-related wireless data to device 1150, which may be used as appropriate by applications running on device 1150.

Device 1150 may also communicate audibly using audio codec 1160, which may receive spoken information from a user and convert it to usable digital information. Audio codec 1160 may likewise generate audible sound for a user, such as through a speaker, e.g., in a handset of device 1150. Such sound may include sound from voice telephone calls, may include recorded sound (e.g., voice messages, music files, etc.) and may also include sound generated by applications operating on device 1150.

The computing device 1150 may be implemented in a number of different forms, as shown in the figure. For example, it may be implemented as a cellular telephone 1118. It may also be implemented as part of a smart phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 11 can include sensors that interface with a virtual and/or augmented reality (VR/AR) headset 1190. The eyewear 100 of FIG. 1 and the eyewear 200 of FIG. 2 are examples of AR headsets. For example, one or more sensors included on a computing device 1150 or other computing device depicted in FIG. 11, can provide input to VR headset 1190 or in general, provide input to a VR space. The sensors can include, but are not limited to, a touchscreen, accelerometers, gyroscopes, pressure sensors, biometric sensors, temperature sensors, humidity sensors, and ambient light sensors. The computing device 1150 can use the sensors to determine an absolute position and/or a detected rotation of the computing device in the VR space that can then be used as input to the VR space. For example, the computing device 1150 may be incorporated into the VR space as a virtual object, such as a controller, a laser pointer, a keyboard, a weapon, etc. Positioning of the computing device/virtual object by the user when incorporated into the VR space can allow the user to position the computing device to view the virtual object in certain manners in the VR space. For example, if the virtual object represents a laser pointer, the user can manipulate the computing device as if it were an actual laser pointer. The user can move the computing device left and right, up and down, in a circle, etc., and use the device in a similar fashion to using a laser pointer.

In some implementations, one or more input devices included on, or connect to, the computing device 1150 can be used as input to the VR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 1150 when the computing device is incorporated into the VR space can cause a particular action to occur in the VR space.

In some implementations, a touchscreen of the computing device 1150 can be rendered as a touchpad in VR space. A user can interact with the touchscreen of the computing device 1150. The interactions are rendered, in VR headset 1190 for example, as movements on the rendered touchpad in the VR space. The rendered movements can control objects in the VR space.

In some implementations, one or more output devices included on the computing device 1150 can provide output and/or feedback to a user of the VR headset 1190 in the VR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 1150 may appear as another object in a computer-generated, 3D environment. Interactions by the user with the computing device 1150 (e.g., rotating, shaking, touching a touchscreen, swiping a finger across a touch screen) can be interpreted as interactions with the object in the VR space. In the example of the laser pointer in a VR space, the computing device 1150 appears as a virtual laser pointer in the computer-generated, 3D environment. As the user manipulates the computing device 1150, the user in the VR space sees movement of the laser pointer. The user receives feedback from interactions with the computing device 1150 in the VR space on the computing device 1150 or on the VR headset 1190.

A number of embodiments have been described. Nevertheless, it will be understood that various modifications may be made without departing from the spirit and scope of the invention.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

In the following some examples are described.

Example 1: An eyewear comprising:

a frame configured to hold a first lens and a second lens;

a first temple connected to the frame using a first hinge; and

a second temple connected to the frame using a second hinge, wherein:
at least one of the frame, the first temple and the second temple includes one or more electronic components, and
a portion and/or part of at least one of the frame, the first hinge and the second hinge provides for an access point for accessing signals from the one or more electronics components by connecting an external device to the access point.

Example 2: The eyewear as in example 1 wherein a corresponding portion or part may be present in a nose bridge or nose pad of the frame or formed by a pin of the first or second hinge, in particular by a replaceable pin.

Example 3: The eyewear as in example 1 or 2 wherein an interface portion for electrically connecting the one or more electronic components is provided at the frame and/or at least one of the first and second hinges, where the first pin is arranged at the interface portion and configured to be removed and replaced by a second (access) pin, e.g., by a second pin differing in length from the first pin, if access to access signals from the one or more electronic components is to be provided via the interface portion.

Example 4: An eyewear comprising:
a frame configured to hold a first lens and a second lens;
a first temple connected to the frame using a first hinge; and
a second temple connected to the frame using a second hinge, wherein:
at least one of the first temple and the second temple includes one or more electronic components, and
at least one of the first hinge and the second hinge is electrically connected to at least one of the electronic components and is used as an electrical contact to access signals from the electronic components.

Example 5: The eyewear as in any of the preceding examples, wherein both the first hinge and the second hinge are electrically connected to at least one of the electronic components and are used as electrical contacts to access the signals from the electronic components.

Example 6: The eyewear as in any of the preceding examples, wherein:
the one or more electronic components include a debug port;
the first hinge is used to access universal asynchronous receiver-transmitter transmit (UART TX) signals from the debug port; and
the second hinge is used to access universal asynchronous receiver-transmitter receive (UART RX) signals from the debug port.

Example 7: The eyewear as in any of the preceding examples, wherein:
the first hinge includes a first pin that is electrically connected to at least one of the electronic components and is used as an electrical contact to access the signals from the electronic components; and
the second hinge includes a second pin that is electrically connected to at least one of the electronic components and is used as an electrical contact to access the signals from the electronic components.

Example 8: The eyewear as in any of the preceding examples, wherein the frame further comprises a nose bridge and the nose bridge is electrically connected to at least one of the electronic components and is used as an electrical contact to access signals from the electronic components.

Example 9: The eyewear as in any of the preceding examples, wherein the frame further comprises nose pads and the nose pads are electrically connected to at least one of the electronic components and are used as electrical contacts to access signals from the electronic components.

Example 10: The eyewear as in any of the preceding examples, wherein: the one or more electronic components include a switch and a debug microcontroller; an output of the switch electrically connects to the first hinge and the second hinge; and access to the signals from the one or more electronic components by the first hinge and the second hinge are controlled by the debug controller through the switch.

Example 11: The eyewear as in any of the preceding examples, wherein the signals from the electronic components are transitioned from a disabled state to an enabled state.

Example 12: An eyewear comprising:
a frame configured to hold a first lens and a second lens;
a first temple connected to the frame using a first hinge;
a second temple connected to the frame using a second hinge; and one or more pins on an outside of the frame, wherein:
at least one of the first temple and the second temple includes one or more electronic components, and
at least one of the one or more pins is electrically connected to at least one of the one or more electronic components and is used as an electrical contact to access signals from the electronic components.

Example 13: The eyewear of example 12, wherein the one or more pins include one or more cosmetic fasteners.

Example 14: The eyewear example 12 or example 13, wherein both the first hinge and the second hinge are electrically connected to at least one of the electronic components and are used as electrical contacts to access the signals from the electronic components.

Example 15: The eyewear of any of the examples 12 to 14, wherein:
the one or more electronic components include a debug port;
the one or more pins include a first pin and a second pin;
the first pin is used to access universal asynchronous receiver-transmitter transmit (UART TX) signals from the debug port; and
the second pin is used to access universal asynchronous receiver-transmitter receive (UART RX) signals from the debug port.

Example 16: The eyewear of any of the examples 12 to 15, wherein the frame further comprises a nose bridge and the nose bridge is electrically connected to at least one of the electronic components and is used as an electrical contact to access signals from the electronic components.

Example 17: The eyewear of any of the examples 12 to 16, wherein the frame further comprises nose pads and the nose pads are electrically connected to at least one of the electronic components and are used as electrical contacts to access signals from the electronic components.

Example 18: The eyewear of any of the examples 12 to 17, wherein the signals from the electronic components are transitioned from a disabled state to an enabled state.

Example 19: An eyewear comprising:
a frame configured to hold a first lens and a second lens;
a first temple connected to the frame using a first hinge;
a second temple connected to the frame using a second hinge; and
a first pin on an outside of the frame, wherein:
at least one of the first temple and the second temple includes one or more electronic components, and
the first pin is removable and replaceable by a second pin that is electrically connected to at least one of the components and is used as an electrical contact to access signals from the electronic components.

Example 20: The eyewear of example 19 wherein an interface portion for electrically connecting the one or more electronic components is provided at the frame and/or at least one of the first and second hinges, wherein the first pin is arranged at the interface portion and configured to be removed and replaced by a second (access) pin, e.g., by a second pin differing in length from the first pin, if access to access signals from the one or more electronic components is to be provided via the interface portion.

Example 21: A method for accessing signals on eyewear, the method comprising: triggering a debug mode on the eyewear, wherein the eyewear includes a frame configured to hold a first lens and a second lens, a first temple connected to the frame using a first hinge, a second temple connected to the frame using a second hinge, and one or more electronic components; and accessing signals from the one or more electronic components through at least one of the first hinge and the second hinge.

Example 22: The method as in example 21, wherein accessing the signals comprises accessing the signals from the one or more electronic components by both the first hinge and the second hinge.

Example 23: The method as in any of the examples 21 to 22, wherein accessing the signals further comprises:
accessing universal asynchronous receiver-transmitter transmit (UART TX) signals through the first hinge; and
accessing universal asynchronous receiver-transmitter receive (UART RX) signals through the second hinge.

Example: 24: The method as in any of the examples 21 to 23, wherein the frame comprises a nose bridge and the method further comprises accessing the signals from the one or more electronic components through the nose bridge.

Example 25: The method as in any of the examples 21 to 24, wherein the frame further comprises nose pads and the method further comprises accessing the signals from the one or more electronic components through the nose pads.

1. An eyewear comprising:
a frame configured to hold a first lens and a second lens;
a first temple connected to the frame using a first hinge; and
a second temple connected to the frame using a second hinge, wherein:
at least one of the first temple and the second temple includes one or more electronic components, and
at least one of the first hinge and the second hinge is electrically connected to at least one of the electronic components and is used as an electrical contact to access signals from the electronic components.

2. The eyewear of claim 1, wherein both the first hinge and the second hinge are electrically connected to at least one of the electronic components and are used as electrical contacts to access the signals from the electronic components.

3. The eyewear of claim 2, wherein:
the one or more electronic components include a debug port;
the first hinge is used to access universal asynchronous receiver-transmitter transmit (UART TX) signals from the debug port; and
the second hinge is used to access universal asynchronous receiver-transmitter receive (UART RX) signals from the debug port.

4. The eyewear of claim 2, wherein:
the first hinge includes a first pin that is electrically connected to at least one of the electronic components and is used as an electrical contact to access the signals from the electronic components; and
the second hinge includes a second pin that is electrically connected to at least one of the electronic components and is used as an electrical contact to access the signals from the electronic components.

5. The eyewear of claim 1, wherein the frame further comprises a nose bridge and the nose bridge is electrically connected to at least one of the electronic components and is used as an electrical contact to access signals from the electronic components.

6. The eyewear of claim 1, wherein the frame further comprises nose pads and the nose pads are electrically connected to at least one of the electronic components and are used as electrical contacts to access signals from the electronic components.

7. The eyewear of claim 1, wherein:
the one or more electronic components include a switch and a debug microcontroller;
an output of the switch electrically connects to the first hinge and the second hinge; and
access to the signals from the one or more electronic components by the first hinge and the second hinge are controlled by the debug controller through the switch.

8. The eyewear of claim 1, wherein the signals from the one or more electronic components are transitioned from a disabled state to an enabled state.

9. An eyewear comprising:
a frame configured to hold a first lens and a second lens;
a first temple connected to the frame using a first hinge;
a second temple connected to the frame using a second hinge; and
one or more pins on an outside of the frame, wherein:
at least one of the first temple and the second temple includes one or more electronic components, and
at least one of the one or more pins is electrically connected to at least one of the one or more electronic components and is used as an electrical contact to access signals from the electronic components.

10. The eyewear of claim 9, wherein the one or more pins include one or more cosmetic fasteners.

11. The eyewear of claim 9, wherein both the first hinge and the second hinge are electrically connected to at least one of the electronic components and are used as electrical contacts to access the signals from the electronic components.

12. The eyewear of claim 9, wherein:
the one or more electronic components include a debug port;
the one or more pins include a first pin and a second pin;
the first pin is used to access universal asynchronous receiver-transmitter transmit (UART TX) signals from the debug port; and
the second pin is used to access universal asynchronous receiver-transmitter receive (UART RX) signals from the debug port.

13. The eyewear of claim 9, wherein the frame further comprises a nose bridge and the nose bridge is electrically connected to at least one of the electronic components and is used as an electrical contact to access signals from the electronic components.

14. The eyewear of claim 9, wherein the frame further comprises nose pads and the nose pads are electrically connected to at least one of the electronic components and are used as electrical contacts to access signals from the electronic components.

15. The eyewear of claim 9, wherein the signals from the one or more electronic components are transitioned from a disabled state to an enabled state.

16. An eyewear comprising:
a frame configured to hold a first lens and a second lens;
a first temple connected to the frame using a first hinge;
a second temple connected to the frame using a second hinge; and
a first pin on an outside of the frame, wherein:
at least one of the first temple and the second temple includes one or more electronic components, and
the first pin is removable and replaceable by a second pin that is electrically connected to at least one of the components and is used as an electrical contact to access signals from the electronic components.

17. A method for accessing signals on eyewear, the method comprising:
triggering a debug mode on the eyewear, wherein the eyewear includes a frame configured to hold a first lens and a second lens, a first temple connected to the frame using a first hinge, a second temple connected to the frame using a second hinge, and one or more electronic components; and
accessing signals from the one or more electronic components through at least one of the first hinge and the second hinge.

18. The method as in claim 17, wherein accessing the signals comprises accessing the signals from the one or more electronic components by both the first hinge and the second hinge.

19. The method as in claim 18, wherein accessing the signals further comprises:
accessing universal asynchronous receiver-transmitter transmit (UART TX) signals through the first hinge; and
accessing universal asynchronous receiver-transmitter receive (UART RX) signals through the second hinge.

20. The method as in claim 17, wherein the frame comprises a nose bridge and the method further comprises accessing the signals from the one or more electronic components through the nose bridge.

21. The method as in claim 17, wherein the frame further comprises nose pads and the method further comprises accessing the signals from the one or more electronic components through the nose pads.
